(19) United States
(12) Patent Application Publication
(10) Pub. No.: US 2013/0013207 A1
(43) Pub. Date: Jan. 10, 2013

(54) SUPPORT SYSTEM FOR USE WHEN MANAGING ICE

(75) Inventor: Per FREJVALL, Saltsjobaden (SE)

(73) Assignee: ARTIC ICE MANAGEMENT AB, Skarhamn (SE)

(21) Appl. No.: 13/178,731

(22) Filed: Jul. 8, 2011

(51) Int. Cl. G06F 19/00; G01W 1/06

(52) U.S. Cl. 702/3; 702/5

(57) ABSTRACT

Support system for use when managing ice in an operation area at sea, where a computer system (11) displays a composite view of at least two superpositioned, geographically referenced graphical layers (310,311,312;410,411;510,512;610,611,612,613;710,711), which layers represent geographically distributed information and share the same geographically referenced coordinate system on the display, where at least one first layer represents information which moves with the ice drift over time, and at least one second layer represents geographically stationary information, where a time input element (302;402;502;602;702) receives a current display time input setting selected along a continuous time scale, and where the computer system updates the displayed layers in response to an input of a current display time, whereby the first layer is translated in accordance with the ice drift between the time stamp and the current display time.

The present invention relates to a support system for use when managing ice in an operation area at sea.

During industrial activity at sea, such as deep ocean drilling from a drilling vessel, close attention must be paid to ice conditions at the operation point for the activity. Since the drill at the sea bed is fixed to the vessel at the surface, too high ice pressure on the vessel, or a collision with a major ice floe, may cause damage to equipment or, in worst case, personal injury or environmental damage.

Therefore, ice in the area surrounding the operation site must usually be managed by one or several icebreaking vessels. Since it is not uncommon for the ice to drift with a velocity of about 1 knot, decisions as to how to prioritize which ice covered area to manage with which available icebreaking vessel must often be taken very quickly. On the other hand, many different parameters affect the ice drift direction and velocity, and the information load on the decision makers is heavy in terms of maps, forecasts, meteorological data and so forth. The available information is also typically incomplete, for example with respect to statistical uncertainty, geographical coverage and time relevance.

There are also several types of parties in a large-scale operation at sea who need access to different subsets of the available information in order to make correct decisions, including operation planners, the fleet master and captains of the various vessels involved.

Hence, it is an object of the present invention to achieve an efficient way to allow the parties involved in such an operation at sea under icy conditions to make better use of the available information.

Thus, the invention relates to a support system for use when managing ice in an operation area at sea, which support system comprises a database comprising information regarding ice drift in the operation area over time and graphical data representing the ice situation in the operation area at a specific point in time, in which a computer system is arranged to cause a display device to display a composite view of at least two superpositioned, geographically referenced graphical layers, which layers represent geographically distributed information and share the same geographically referenced coordinate system on the display, which layers furthermore comprise at least one first graphical layer, representing geographically distributed information which moves with the ice drift over time and is associated with a time stamp representing the time at which the geographically referenced information is valid; and at least one second graphical layer, arranged to represent geographically stationary information, where at least one of the said at least one first layers is a layer representing said ice situation, and is characterised in that the system further comprises a current time input means arranged to receive a current display time input setting selected along a continuous time scale, and in that the computer system is arranged, in response to an input of a current display time, to update the displayed layers, whereby the geographical reference of the at least first layer is translated in accordance with the ice drift between the time stamp and the current display time.

In the following, the invention will be described in detail, with reference to exemplifying embodiments of the invention and to the appended drawings, where:

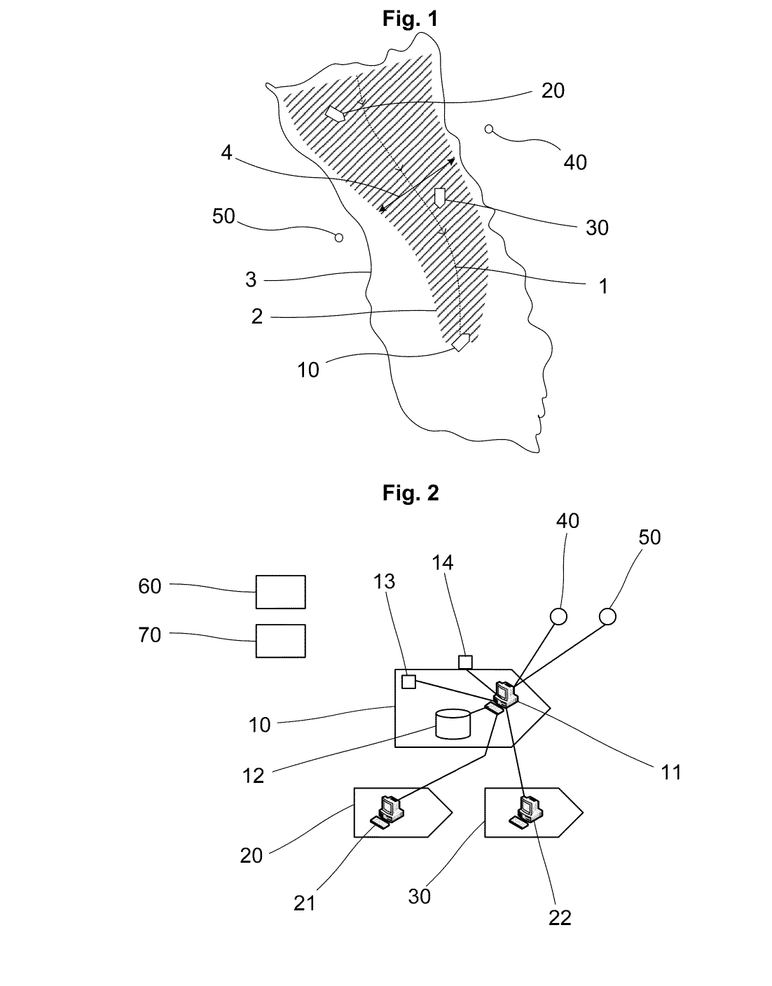

FIG. 1 is an overview diagram of an ice managed area at sea;

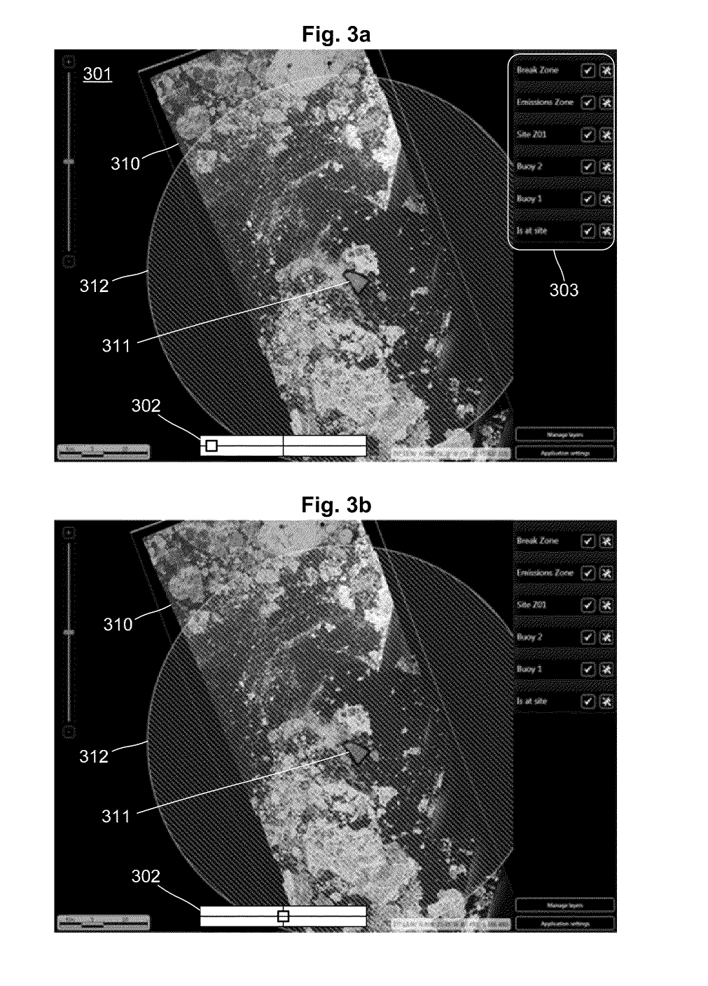

FIG. 2 is a schematic overview of a system for performing a method according to the present invention;

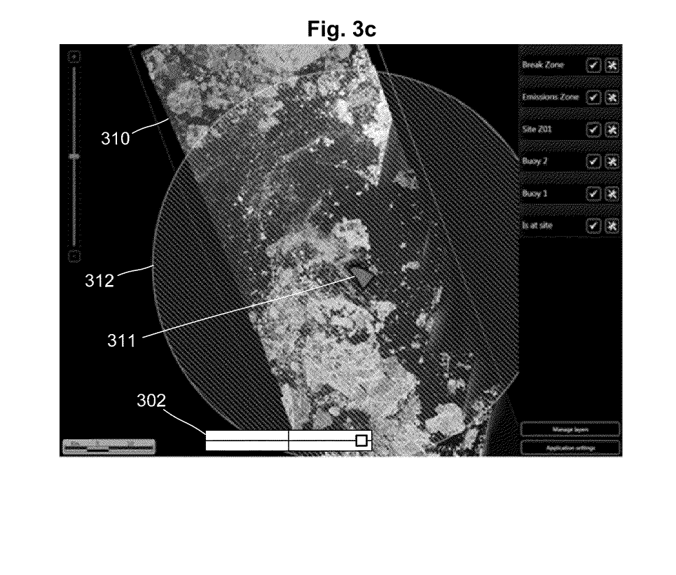

FIGS. 3a-3c show a composite view of three different layers according to the present invention at three different points in time;

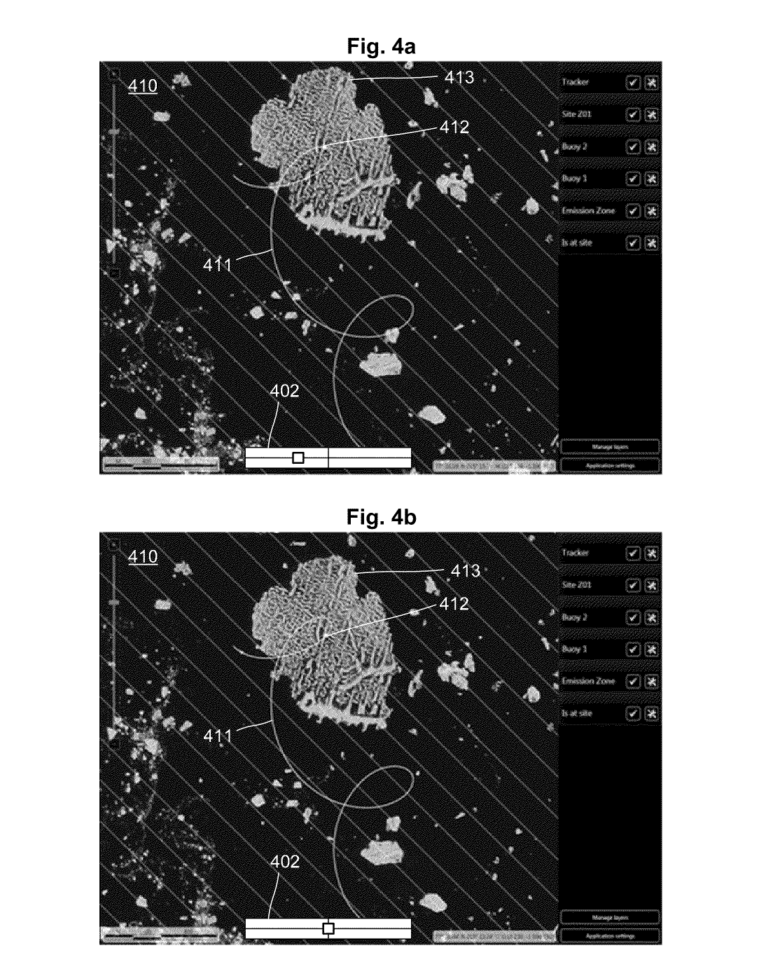

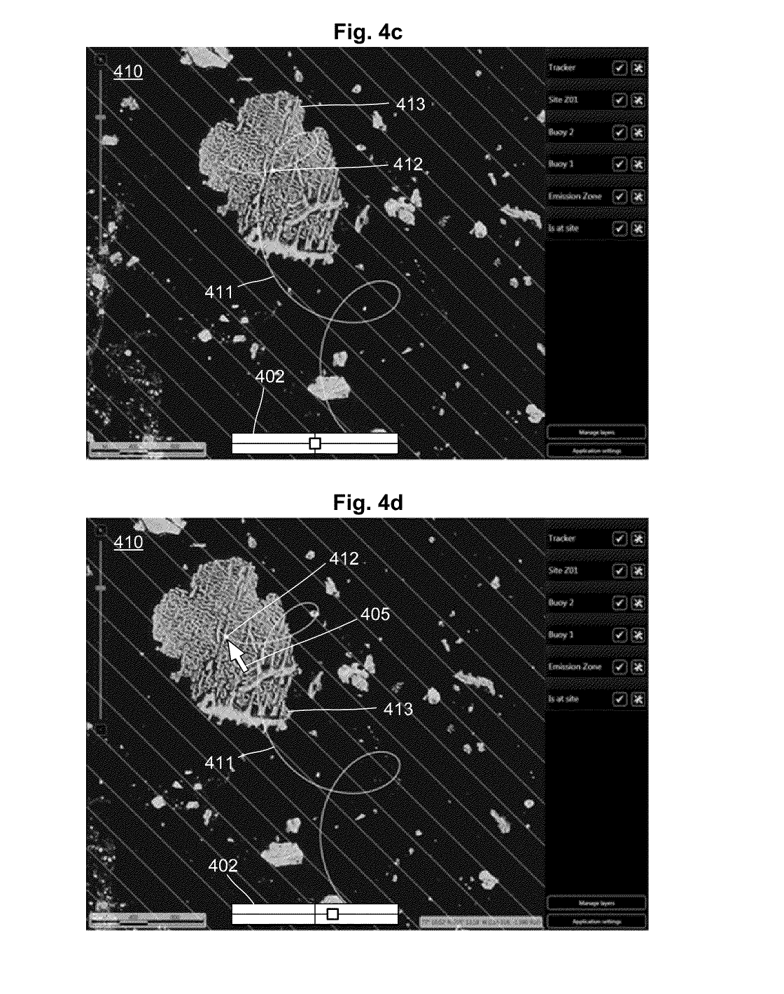

FIGS. 4a-4d show a composite view of two different layers according to the present invention at four different points in time;

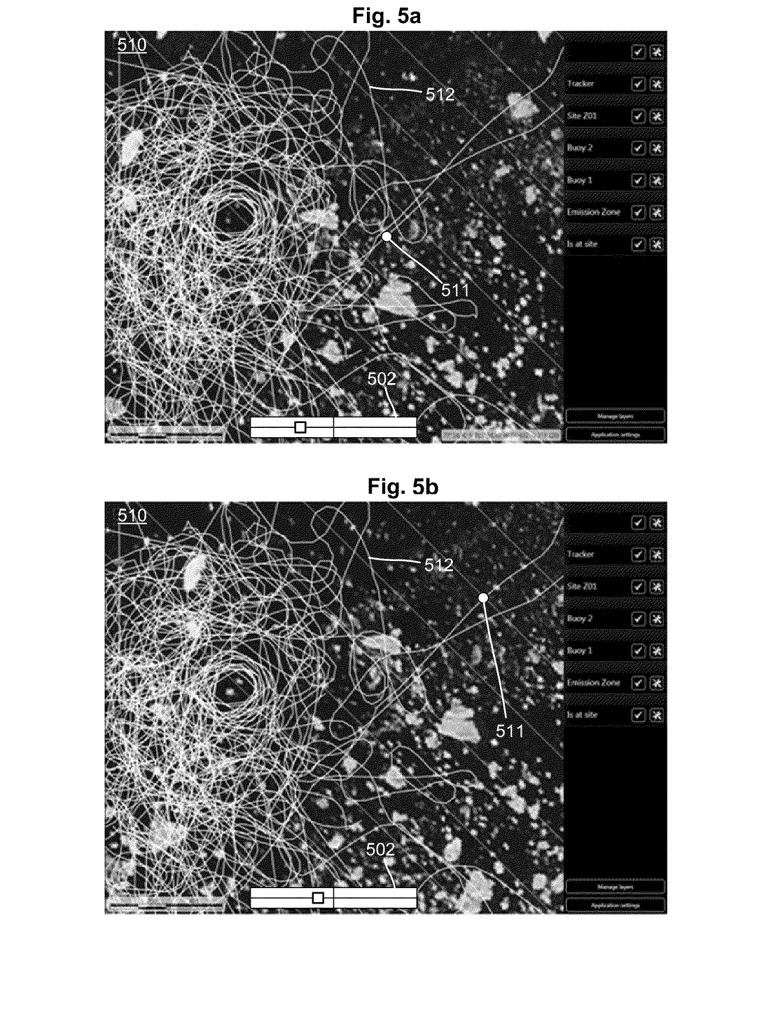

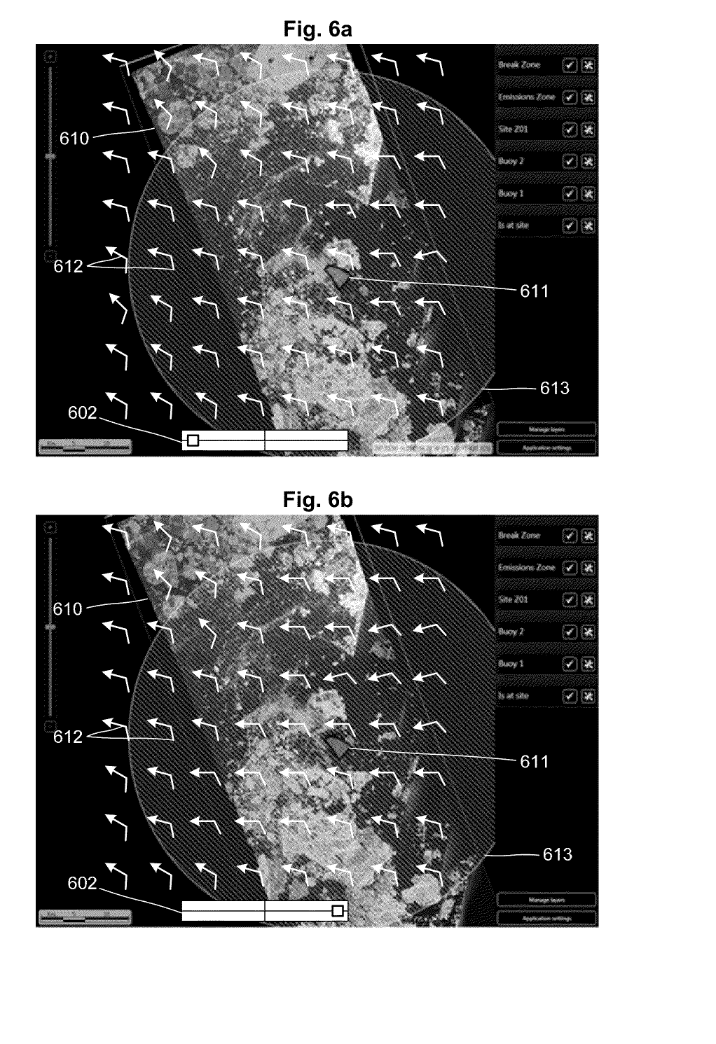

FIGS. 5a-5b show a composite view of two different layers according to the present invention at three different points in time;

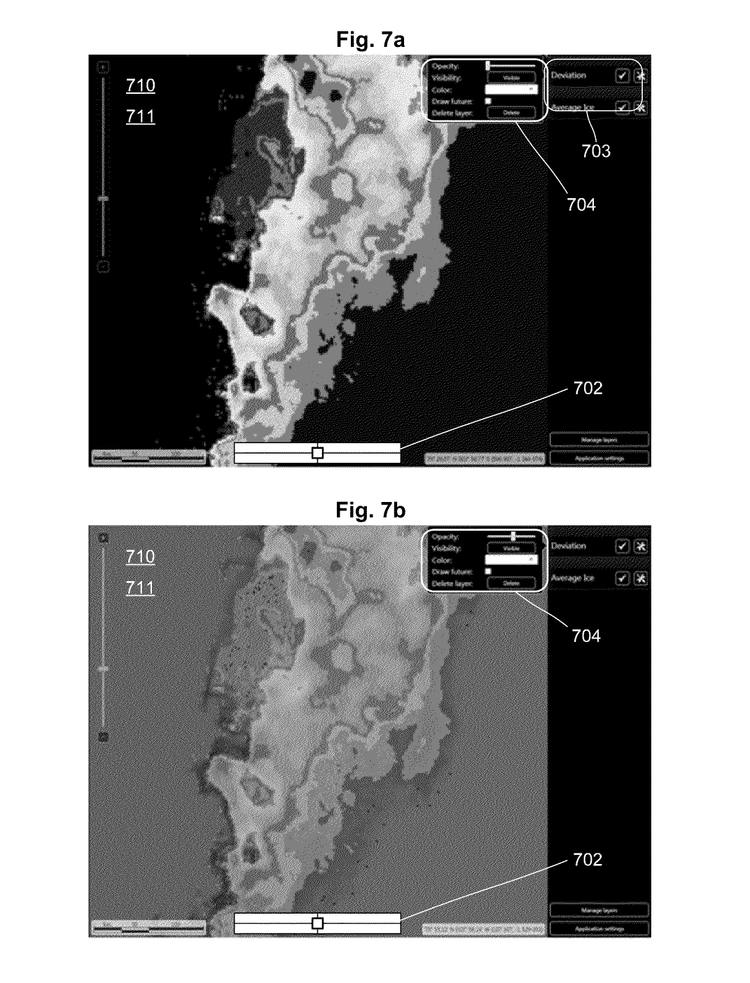

FIGS. 6a-6b show a composite view of four different layers according to the present invention at two different points in time; and

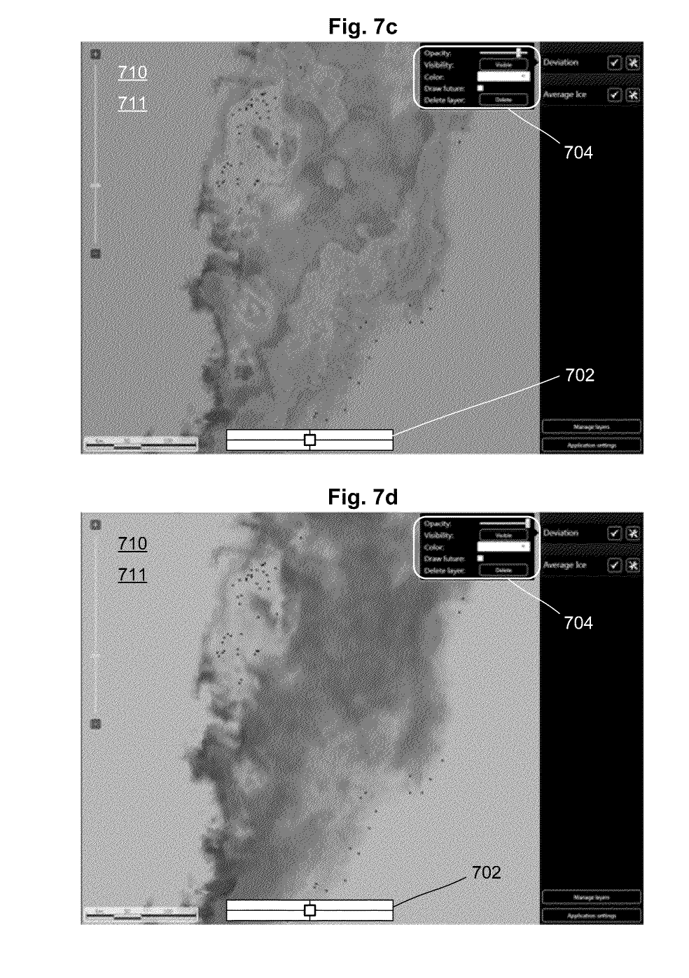

FIGS. 7a-7d show a composite view of two different layers according to the present invention at the same time but with four different opacity settings;

FIG. 1 illustrates a typical situation during industrial operation at sea. A drilling vessel 10 is located at an operation point which is ice managed. That the operation point is “ice managed” is to be interpreted so that the water at the operation point is controlled regarding its ice conditions so that the industrial operations at the operation point are not threatened by ice floes at or near the operation point. The ice managed area is delimited by the line 3, outside of which the water is at least partly covered with ice and inside of which the ice cover has been managed to successively smaller maximum floe sizes the further said floes are distanced from the operation point upstream in ice drift direction. The shape of the line 3 is determined by the historic ice drift and the past ice managing activity.

It is to be understood that instead of a fixed operation point, a possibly curved operation line may be used, such as for example along a pipeline on the sea bed. Along such a line there may be any number of fixed work points. Furthermore, operations may be related to a set of fixed lines, such as for seismic measurements using dragging hydrophore equipment along predetermined parallel lines across the ice covered water. In the presentation herein, what is said in relation to an operation point is analogously applicable to an operation line or lines, where a certain area around the operation line or lines needs to be ice managed with the same purpose of lowering the risk of a fatal collision with an ice floe or the like.

The predicted or forecast ice drift is shown using a line 1, and an area 2 (hatched) to be properly ice managed extends from the operation point, covering the ice path which according to a current ice drift forecast will later pass through the operation point due to ice drift. Since the ice drift forecast is associated with some uncertainty, the width 4 of the area 2, perpendicularly to the forecast ice path, is larger the longer the time before the respective point along the ice path will pass the operation point according to the forecast.

Two icebreakers 20, 30 work together to manage the incoming ice in order to guarantee safe operations at the vessel 10 position or operation point. Two measurement stations 40, 50 are fixed to and drift along with the ice, and are arranged to measure their respective direction and velocity over time. Such stations may be in the form of ice buoys or the like, and are deployed using icebreaking vessels 20, 30, a helicopter or similarly.

FIG. 2 is a high-level diagram showing the system setup, using the same reference numerals as in FIG. 1. Onboard the drilling vessel 10, there is a computer system 11 arranged to gather the data, perform forecast calculations etc., as described below. The computer system 11 is also arranged to display the forecasts produced by the method according to the present invention to a user and/or to feed the forecast data into the existing ice management planning and operation system installed on the drilling vessel or otherwise.

The icebreakers 20, 30, as well as the measurement stations 40, 50, are all connected to the computer system 11 on the drilling vessel 10, whereby for example location information from the buoys 40, 50 may continuously be sent to the computer system 11. Furthermore, an external source 60 of information, such as a forecast supplier, is connected to the computer system 11. Another external source 70 of information, such as a satellite image supplier, is likewise connected to the computer system 11.

A measurement station 13 is arranged to continuously measure the current wind vector and other locally measurable data, such as air pressure and geographical location. A database 12 is arranged to store available data, such as delivered forecasts and imagery, locally measured data, etc. The database 12 may be standalone or for example incorporated as a functional part of the computer system 11.

Communications between external suppliers 60, 70 and the computer system 11, but also between the computer system 11 and the operation internal components 20, 30, 40, 50, may in practice be facilitated via a wireless communication system 13, which may be conventional as such. It is also realized that the computer system 11 may also be installed at a location which is not on the drilling vessel 10.

Vessels 20, 30 also feature one respective computer 21, 22 each, with a respective information screen.

According to the present invention, at least the computer system 11 with its display and the database 12 are comprised in a support system for use when managing ice in an operation area at sea, comprising the above mentioned operation point.

The database 12 comprises information regarding ice drift in the operation area over time and graphical data representing the ice situation in the operation area at a specific point in time. It also comprises other graphically viewable data in raster image format, vectorized format or the like. The computer system 11 is arranged to cause at least one of the respective display devices at the drilling vessel 10 and the icebreaking vessels 20, 30 to display a composite view of at least two superpositioned, geographically referenced graphical layers, which layers represent geographically distributed information and share the same geographically referenced coordinate system on the said display.

Herein, the expression “composite view of superpositioned layers” refers to a single graphical view, displayable on a pixel-based computer display, which may be conventional as such, composed of several images which are displayed at the same time on the display, such that information shown in one layer may hide information shown in another layer. Due to, for example, transparency of pixels in individual layers and different extension of individual layers on the display, information may be shown relating to several layers in such a composite view at the same time.

That the layers represent “geographically distributed information” and “share the same geographically referenced coordinate system on the display” is to be interpreted so that the pixels of each individual layer are mapped onto a geographical position in a two-dimensional grid and that each respective pixel represents some information relating to its corresponding geographical position. Furthermore, the said mapping is the same for each individual layer, in the sense that a certain displayed pixel on the display refers to substantially the same or corresponding geographical position for all displayed layers. It is realized that underlying data for each layer may have different geographical resolutions, may not share the same exact geographical reference point, etc., so that the geographical location corresponding to a certain displayed pixel may differ somewhat between different layers. What is important is that the displayed pixel information for each layer corresponds to substantially the same geographical location so that layer information can be compared on pixel level between layers. This may for example be achieved by downsampling imagery, interpolating measurement points, and other similar techniques. It is also realized that different layers may have different geographical extension, and may or may not overlap completely or partially.

According to the invention, the displayed layers furthermore comprise at least one layer of a first category of layers, representing geographically distributed information which moves with the ice drift over time. Thus, the information carried by the pixels of such a first category layer is tied to the ice cover in the sense that it in the real world moves with the ice cover, or that the object(s) to which the information relates move(s) with the ice in the real world. Thus, the information may relate to the ice itself, such as satellite image data showing the ice cover, or ice density data.

Such a first category layer is associated with a time stamp, representing the time at which the geographically referenced information is valid. In other words, the time stamp reflects the point in time when some image data or the like, depicting a certain predetermined geographically referenced and geographic area actually constituted a true depiction of that area. In case of a satellite image layer, the time stamp may for instance be the time at which the image was captured.

According to the invention, at least one of the first category layer(s) is a layer representing the ice situation.

The displayed layers also comprise at least one layer of a second category of layers. Layers of this second category are arranged to represent geographically stationary information. Thus, such information does not move with the ice cover as time shifts. In fact, it is always immobile geographically.

FIG. 3a shows the screen display 301 of one of the above mentioned information screens. Among other things, the display 301 features a time input means 302, via which the user can input a current viewing time using a conventional computer mouse, touch screen technology or the like, and an active layers control 303, via which the user can control the appearance of displayed layers. FIGS. 3b-7d also show similar screen displays.

In addition, there is shown a first category layer 310 in the form of a photograph of the ice cover; a second category layer 311 marking a currently calculated area to be ice managed, similar to the area 2 shown in FIG. 1; and a second category layer 312 marking a zone within which there are regulatory requirements imposed on maximum carbon dioxide emissions from the operation.

Other useful second category layers include coastal lines, borders and other map data, as well as other types of zones such as allowed drilling zones.

As is clear from FIG. 3a, all three layers are displayed in a superpositioned fashion as described above. All pixels of layers 311 and 312 are completely transparent except for those displaying the mentioned ice managed area and emission regulated zone. The layers are displayed on top of each other. Using the control 303, a user may, using a conventional computer mouse, touch screen technology or the like, alter the opacity of each individual layer, such that lower-order layers shine through more or less, and the viewing order itself of the layers. The user may also, using the control 303, turn on or off the visibility of individual layers. Furthermore, individual layers may be selected for highlighting, whereby their relative viewing intensity and opacity are changed for a more distinct appearance on the display as compared to other layers. The computer system 11 is arranged to update the image displayed on the display 301 in response to user input activity via the said layer control means 303.

In this case, the first category layer 310 is not a satellite image, but is rather a stitched together series of aerial photos of the ice. After the stitching together of the said series of photos, the combined photo was geographically referenced by finding a corresponding geographical location of a certain pixel of origin in the combined photo, which was valid at a certain point in time. This means that different individual such aerial photos that were taken at different points in time were moved slightly since the ice had time to drift a certain distance between the photos were taken.

At least one first category layer may also comprise a raster image representing geographically referenced data, where each raster point represents non-photographic data such as ice concentration, ice density and ice type. Such information also moves together with the ice cover as time goes by.

According to a preferred embodiment, at least one vessel 10, 20, 30 is equipped with measuring equipment such as a radar, the captured images from which are fed to the database 12. In this case, these images are published by the computer system 11 as available first category layers as they become available in the database 12.

The second category layers 311, 312 have also been geographically referenced in a similar fashion, with the exception that no time stamp needs to be stored together with such layer since it is stationary over time. Each one of the displayed second category layers 311, 312 may in this case be stored in the database 12 either as raster images or as vectorized or parameterized data sets.

As mentioned above, the time input means 302 is arranged to receive a current display time input setting. The time input means 302 may be arranged in any suitable way, but it is preferred that each information screen is equipped with its own independent time input setting.

In FIGS. 3a-7d, such a display time input means 302, 402, 502, 602, 702 is in the form of an interactive, on-screen slider which may be moved by the user using a computer mouse, touch screen technology or the like. The current display time is selected along a continuous time scale, which is shown as a horizontal line along which a square slider can be moved in order to set the current display time corresponding to the horizontal position of the slider. A short vertical line at the horizontal center of the input control 302 represents the time “now”, in other words the actual current time when viewing the display 301.

The total viewable time span may vary depending on the viewed information, but is typically at least several hours.

Irrespective of the setting of the time input means 302, the currently displayed layers on the screen will carry geographically referenced information which was, is or will be exactly or approximately valid at the input current display time. With respect to the first category layer 310, this means that the combined image of the ice has been moved according to the ice drift between the stored time stamp of the image in question and the current time input setting. The ice drift path is read from the database 12, and describes the, possibly curved, path of the ice drift between these two points in time. It is preferred in this context that the ice drift is considered completely described by a path curve, along which the ice cover translates without shearing or stretching. It is, however, preferred that the ice cover can rotate over time, which rotation may be described separately in the database 12. With respect to the two second category layers 311, 312, they will not move from their already referenced position.

Moreover, according to the invention the computer system 11 and/or an individual work station 21, 22 is arranged, in response to an input of a current display time, to update the displayed layers to reflect the new input current display time. Hence, when user inputs a new current display time, by sliding the square time slider, the geographical reference of the at least first layer is translated in accordance with the above described ice drift path between the time stamp and the current display time.

This way, a substantially accurate image of the operation area may be obtained for a range of different times on the basis of information which in itself only covers one or several individual, single points in time. Thus, the useful life of an available image can be prolonged by moving it together with the ice drift. Instead of a validity of minutes for an aerial photograph, it may now be used for substantially longer periods, even for a day or more, for the purposes of taking decisions based upon the development of the ice conditions in the operation area.

It is also possible to quickly obtain an overview of dynamic processes in the operation area, by displaying a composite image of the herein described type at consecutive points in time and observing the development of the ice situation, etc., over time, in relation to the operation point. This allows for more efficient ice management planning and prioritization, both on an overview level by the fleet master as well as on the local level of individual ice breaking vessel captains.

Moreover, the composite view of the current invention allows different types of information to be displayed in a geographically correct manner in relation to each other, for different points in time. This does not only mean that different types of maps may be used seamlessly and simultaneously for easy comparison, but also that measurements may be performed for predetermined points in time across map data and ice drift dependent data, such as the position in relation to the operation point of an approaching, large floe of ice. Also, quick information reference functions are made possible relating to several types of information at once and to a certain point on the screen. As an example, when the user selects a certain pixel containing ice cover density and being close to a vessel trackline, the ice concentration as a number and/or the time at which the vessel went past the closest point along the trackline may be automatically displayed.

FIG. 3b illustrates the same composite view as that in FIG. 3a, but after the user has moved the time input means to the setting “now” (on the centrally located vertical line). As a response to this new input current display time, the first category layer 310 has been moved along the historical ice drift path as measured by the buoys 40, 50 between the display time of FIG. 3a and the actual current time at the time of display of FIG. 3b. The second category layers 311, 312, on the other hand, have not moved.

FIG. 3c then illustrates the same composite view once more, but now after the user as a new current display time has selected a future point in time (to the right of the said vertical line), that is a time which has not yet occurred at the actual time at which the composite image of FIG. 3c was produced and viewed.

In this case, the database 12 comprises both historic and forecast, future information regarding ice drift. The forecast ice drift information may be produced locally, by the computer system 11, or may be delivered from an external source 60, 70. When the user moves the current time input means from a previous or current time to a future time or vice versa, the computer system 11 is arranged to use as the ice drift path used to translate the first category layer the concatenation of the historic and forecast ice drift information comprised in the database 12 so that a connected ice drift path covering past, present and future drift pattern results.

It is preferred, as is illustrated in FIGS. 3a-3c, that the current display time input means comprises a single, continuous time scale for current display time input, which time scale comprises both historic, actual and future times. Certain layers may not comprise information relating to certain time periods, which is the case for instance regarding forecast information which is not available for past times and measured tracklines of ships or the like, which are not available for future times. In such cases, it is preferred that such layers that lack information at a certain selected display time may be hidden when using that display time.

It is preferred that the user may move the current time input means in a continuous manner, so that layers moving with the ice drift move along the screen in a continuous fashion as the user moves the time input means, and so that all other layers are updated correspondingly by the computer system.

This way, a user may seamlessly and continuously shift the information displayed on-screen across past, present and future times in order to investigate the already factual ice behavior of the past and the expected ice behavior of the future, and this way to quickly gain a detailed yet overview picture of how the ice situation is expected to develop in relation to the operation point.

FIGS. 4a-4d show a similar stitched-photo first category layer 410 as the layer 310 as described above, but each pixel in FIGS. 4a-4d represent a larger area than what is the case for FIGS. 3a-3c.

Furthermore, FIGS. 4a-4d show a layer 411 of a third category. Layers of this third category represent the geographically referenced trajectory of an object over time. The object can be a vessel, such as an icebreaker or a drilling vessel. In FIGS. 4a-4d, however, the object is an ice buoy, which is attached to a large ice floe 413 with the purpose of measuring the ice drift according to the above described.

Thus, the trajectory may be displayed as a continuous, geographically referenced line representing graphically the path of the object. Such a trajectory remains immobile on the screen as the current display time changes. However, the computer system 11 is arranged, in response to an input of the current display time, to update said third category layer on the display by marking, along the trajectory, the position of the object at the current display time.

Thus, in FIGS. 4a-4d, the position of the ice buoy at the respective current display time is marked using a small, solid white dot 412. It is noted that the ice cover layer 410 moves in the same pattern as the trajectory layer 411, and that the position of the buoy 412 in relation to the ice floe 413 is fixed.

In FIG. 4a, the user has set a certain past time as the current display time using the display time input means 402. In FIG. 4b, the user has set the current display time to “now”, and the ice cover layer 410 as well as the buoy 412 has moved to their respective current locations as was the case at the very moment when the user actually set the input means 402.

From FIG. 4b, it is clear that the trajectory 411 is actually a concatenation of the actual historical motion of the ice buoy 412, as measured, and a forecast of its future motion. The forecast may in this case be produced as described above for the ice drift, since the buoy necessarily follows said drift as it is fixed to the ice floe 413.

According to a preferred embodiment, the computer system 11 is arranged to, when the display time input means 402 is set to the actual current time, automatically and continuously step the current display time forward so that it remains set to the actual current time even as time passes, as long as the current display time input means is not set by the user to some other time. Furthermore, the computer system 11 is preferably arranged to continuously update the displayed layers 410, 411 on the display accordingly. This way, a current view of the conditions in the operation area is always displayed on the screen as long as the user keeps the current time input means on the “now” setting.

In the case of FIGS. 4a-4d, the forecast part of the trajectory 411 may preferably be updated based upon the newly gathered measurement data from the buoy 412 as time passes, so that the part of the actual trajectory 411 which represents future times will be modified somewhat as the actual time passes.

Hence, in FIG. 4c, some time has elapsed while the display time input means 402 has remained on the “now” setting. As a consequence, the buoy 412 has moved along the trajectory 411 and the ice cover 410 has shifted in order to reflect the situation at the current actual time.

In this context, it is also preferred that the past and future time settings of the current display time means define respective points in time in relation to the current actual time, such as current actual time +/−1 minute per on-screen pixel along the time slider. The computer system 11 may furthermore be arranged to automatically step forward or not to step forward the current display time as actual time passes, irrespective of the current setting of the current display input means 402, as long as the input means 402 is not set to a new display time.

According to a preferred embodiment, the time input means furthermore comprises an input means allowing the user to select a point along the displayed object trajectory of at least one third category layer, whereby the time at which the vessel was located at the selected point thereby constitutes the new current display time.

This is illustrated in FIG. 4d, where the user, by aid of a conventional computer mouse pointer 405, selects a later point 412 along the third category layer trajectory 411. As a response to this user action, the computer system 11 updates the input means 402 display to the display time corresponding to the selected point 412 along the future, forecast part of the trajectory 411, and also updates all displayed layers according to the new current display time. For reasons of clarity, the pointer 405 is displayed in a position close to the point 412 rather than close to the pixel where the clicking of the mouse occurred (the ice image has moved between FIGS. 4c and 4d).

FIGS. 5a-5b show an example of a third category layer the trajectory 512 of which is not the general ice drift path. To the contrary, the trajectory 512 is the measured, historical path of an icebreaking vessel as described above. For the trajectory 512, no future data is available, and the trajectory ends at the display time “now”, or somewhat before. The position of the vessel is marked using a solid white dot 511. A first category ice cover layer 510 is also displayed. In other respects, the behavior of the layers 510, 512 corresponds to that of layers 410, 411 of FIGS. 4a-4d.

FIG. 5a shows the layers 510, 512 at a certain past display time, and FIG. 5b shows the same layers at a certain later past display time.

FIGS. 6a-6b illustrates a fourth category of layers, representing geographically referenced information which does not move with the ice drift but which changes over time. Such layers are updated by the computer system 11, in response to a change of the current display time, to update the said fourth category layer to the layer information which is valid at the new current display time.

According to a preferred embodiment, such fourth category layers may include at least one of geographically referenced weather information; wind strength and wind direction information; daylight information; air pressure information; air temperature information; surface water stream information; and/or ice dynamic motion information.

Such information may be displayed in various ways, preferably in the form of a raster image wherein different colors or intensity levels indicate different values, or using discreet indicator objects, such as vectors, spread across the displayed image.

In FIGS. 6a-6b, the respective values of a wind direction forecast at a certain historic time (FIG. 6a) and a certain future time (FIG. 6b) are shown using wind direction arrows 612. Apart from this, FIGS. 6a-6b feature, in a way similar to FIGS. 3a-3c, a first category ice image layer 610 and second category carbon dioxide emission zone 613 and ice managed area 611 layers. As is clear from FIGS. 6a-6b, the wind direction forecast indicates a slightly shifting wind pattern between the two displayed times. Alternatively, instead of using the same forecast for both historic and future display times, the most recent available forecast may be used for each respective display time, or actual measurement data may be used whenever available for a certain historic display time. The data used may also preferably be interpolated between, for example, measured and forecast information in order to display the most current data for each display time.

FIGS. 7a-7d illustrate a fifth category of layers, representing geographically referenced uncertainty information regarding the uncertainty of the information contained in another layer. For reasons of clarity, no first category layer is displayed in FIGS. 7a-7d.

The “other layer” in the case of FIGS. 7a-7d is a fourth category layer 710 representing, for each geographically reference displayed image pixel, using a pixel brightness scale, the average historical ice cover for the time of year corresponding to the current display time. The corresponding fifth category layer is a layer 711 displaying, for each geographically reference image pixel and using another pixel brightness scale, the standard deviation of the average ice cover at the same geographic point as displayed in the layer 710. It is noted that the standard deviation in this case is one of several possible measures of the uncertainty of the average ice cover.

In all FIGS. 7a-7d, the standard deviation layer 710 is displayed on top of the average ice cover layer 711.

In FIG. 7a, the opacity of the standard deviation layer 711 is set to completely transparent, as set by the user via a layer control means 704 operating on the standard deviation layer 711 as selected using the active layers control 703. Therefore, the average ice cover layer 710 is the only visible layer.

In FIG. 7d, on the other hand, the opacity of the standard deviation layer 711 has been set to no transparency, why it completely hides the average ice cover layer 711. In FIGS. 7b and 7c, as is clear from the “Opacity” control of the layer control means 704 in each figure, the opacity is positioned between completely transparent and no transparency. The computer system 11 is arranged to automatically update the displayed layers 710, 711 according to changes of the “Opacity” setting.

By selecting different such opacities, the user of the system may very efficiently obtain a more detailed understanding of available ice situation data, such as the said average ice cover data. Highly uncertain data will stand out from more certain data, since the uncertainty data is available on-screen simultaneously and at the same pixel location as the information to which it relates.

It is furthermore possible to display such fifth category uncertainty layers relating to first, second and third category layers. For example, a forecast ice drift path which is displayed as a curve may be associated with an uncertainty layer in the form of a raster image in which the color intensity of each pixel represents the probability that the actual path will pass the geographical position corresponding to said pixel. This way, an operator can quickly grasp how accurate the current ice drift forecast is. Analogously, the shape, location and size of a currently calculated area to be ice managed, like the area 311 of FIGS. 3a-3d, may be based upon uncertain input parameters, such as the forecast ice drift. Typically, the limits of the area 311 are established so as to meet certain criteria for the risk of a harmful, unmanaged ice floe reaching the operation point. Therefore, the exact positions of said limits will depend on the highest risk accepted by the fleet manager. Thus, an uncertainty layer may be associated with the area 311, displaying, using a color intensity scale, the accepted risk by positioning a limit of the area 311 at the respective position represented by each raster pixel.

Furthermore, it is preferred that the computer system 11 also comprises a layer update means, which is arranged to update the information stored in the database 12 with respect to at least one layer, preferably all layers that are subject to change. Such layer update means may, for example, be in the form of a link to an external provider 60, 70 of information. In this case, the computer system 11 is preferably arranged to automatically update the layers displayed on the display upon such update of the information viewed in a displayed layer. For instance, as soon as an update forecast of future temperature for the currently viewed geographic area is available in the database 12, which covers the currently displayed future time, the displayed fourth category layer showing the forecast temperature information will be updated so as to show the recently obtained forecast information.

In the display as described herein, economical, environmental and operational effects of the operation can furthermore be displayed and assessed, including current emissions, fuel consumption and ice breaking progress. Such information may be displayed continuously in a dedicated area of the screen or near a respective displayed object to which the data relates, such as the currently ice managed area. Other information that may be viewed includes time until bunker required and an expected minimum time of uninterrupted operation at the operation point (“T-time”).

The current invention is also useful for managing oil spills. In this case, the oil spill is measured and published as an available first category layer which is continuously updated as fresh measurements are available and otherwise drifts with the ice cover.

Furthermore, it is preferred that each user of the system can customize his view of the situation to fit his needs. This includes, for example, that the fleet master can view a larger geographical area than the captains of icebreaking vessels, who may view a more local geographical area. Pre-operation planning, to the contrary, may be accomplished with large scale views comprised of satellite imagery and ice concentration maps.

Above, preferred embodiments have been described. However, it is apparent to the skilled person than many modifications may be made to the described embodiments without departing from the idea of the invention.

For example, it is possible to display other types of information also in a display according to the present invention, such as text-based information relating to displayed entities.

The above described measurement data collected by vessels 10, 20, 30, fed to the database 12 and published by the computer system 11 as available first category layers may also comprise information published as third or fourth category layers, such as current temperature or wind vector.

Also, it is understood that the examples displayed in FIGS. 3a-7d are selected in order to shed light upon various types of layers, and that these and other examples may be combined in any manner.

Thus, the invention shall not be limited to the described embodiments, but is variable within the scope of the enclosed claims.

1. Support system for use when managing ice in an operation area at sea, which support system comprises a database (12) comprising information regarding ice drift in the operation area over time and graphical data representing the ice situation in the operation area at a specific point in time, in which a computer system (11) is arranged to cause a display device to display a composite view of at least two superpositioned, geographically referenced graphical layers (310,311,312;410,411;510,512;610,611,612,613;710,711), which layers represent geographically distributed information and share the same geographically referenced coordinate system on the display, which layers furthermore comprise
at least one first graphical layer (310;410;510;610), representing geographically distributed information which moves with the ice drift over time and is associated with a time stamp representing the time at which the geographically referenced information is valid; and
at least one second graphical layer (311,312;611,613), arranged to represent geographically stationary information,
where at least one of the said at least one first layers is a layer representing said ice situation, characterised in that the system further comprises a current time input means (302;402;502;602;702) arranged to receive a current display time input setting selected along a continuous time scale, and in that the computer system is arranged, in response to an input of a current display time, to update the displayed layers, whereby the geographical reference of the at least first layer is translated in accordance with the ice drift between the time stamp and the current display time.

2. Support system according to claim 1, characterised in that at least one of said at least one first layers (310;410;510;610) comprises a raster representing geographically referenced satellite or aerial image data.

3. Support system according to claim 1, characterised in that at least one of the said at least one first layers comprises a raster representing geographically referenced data, where each raster point represents non-photographic data such as ice concentration, ice density and ice type.

4. Support system according to claim 1, characterised in that at least one of the said at least one second layers (311,312;611,613) comprises information marking the location of a stationary operation point, a stationary zone, a coastal line or a border.

5. Support system according to claim 1, characterised in that the displayed layers comprise at least one third layer (411;512), representing the geographically referenced trajectory of an object (412;511) over time, and in that the computer system (11) is arranged, in response to a change of the current display time, to update said at least one third layer on the display by marking, along the trajectory, the position of the object at the current display time.

6. Support system according to claim 5, characterised in that the time input means (402;502) comprises an input means allowing the user to select a point (412;511) along the displayed object trajectory (411;512) of said at least one third layer, whereby the time at which the object was located at the selected point constitutes the input time.

7. Support system according to claim 1, characterised in that the displayed layers comprise at least one fourth layer (612), representing geographically referenced information which does not move with the ice drift but which changes over time, and in that the computer system (11) is arranged, in response to a change of the current display time, to update the at least one fourth layer to the layer information which is valid at the current display time.

8. Support system according to claim 7, characterised in that at least one of said at least one fourth layers (612) comprises geographically referenced weather information; wind strength and wind direction information; daylight information; air pressure information; air temperature information; surface water stream information; and/or ice dynamic motion information.

9. Support system according to claim 1, characterised in that the database (12) comprises both historic and forecast, future information regarding ice drift, in that the current display time input means (302;402;502;602;702) is arranged to allow the user to input as the current display time a historic, actual or future time, and in that the ice drift used for translation of the said at least one first layer (310;410;510;610) is the concatenation of the historic and forecast ice drift information comprised in the database.

10. Support system according to claim 9, characterised in that the computer system (11) is arranged to, when the current display time input means (302;402;502;602;702) is set to the actual time, automatically and continuously stepping the current display time forward so that it remains set to the actual time as time passes, as long as the current display time input means is not set by the user to some other time, and also to continuously update the displayed layers on the display accordingly.

11. Support system according to claim 9, characterised in that the database (12) also comprises forecast, future information regarding one or several possible fourth layers (612).

12. Support system according to claim 1, characterised in that the current display time input means (302;402;502;602;702) comprises a single, continuous time scale for current display time input, which time scale comprises both historic, actual and future times.

13. Support system according to claim 1, characterised in that the displayed layers comprise at least one fifth layer (711), representing geographically referenced uncertainty information regarding the uncertainty of the information contained in another layer.

14. Support system according to claim 1, characterised in that the system further comprises a layer control means (303;703), arranged to let the user select visibility, transparency and/or viewing order of available layers, and in that the computer system (11) is arranged to update the image displayed on the display in response to user input activity via the said layer control means.

15. Support system according to claim 1, characterised in that the system further comprises a layer update means, arranged to update the information stored in the database (12) with respect to at least one layer, and in that the computer system is arranged to automatically update the layers displayed on the display upon such update of the information viewed in a displayed layer.

16. Support system according to claim 2, characterised in that at least one of the said at least one first layers comprises a raster representing geographically referenced data, where each raster point represents non-photographic data such as ice concentration, ice density and ice type.

17. Support system according to claim 2, characterised in that at least one of the said at least one second layers (311,312;611,613) comprises information marking the location of a stationary operation point, a stationary zone, a coastal line or a border.

18. Support system according to claim 2, characterised in that the displayed layers comprise at least one third layer (411;512), representing the geographically referenced trajectory of an object (412;511) over time, and in that the computer system (11) is arranged, in response to a change of the current display time, to update said at least one third layer on the display by marking, along the trajectory, the position of the object at the current display time.

19. Support system according to claim 10, characterised in that the database (12) also comprises forecast, future information regarding one or several possible fourth layers (612).
